(19) United States
(12) Patent Application Publication
(10) Pub. No.: US 2005/0046131 A1
(43) Pub. Date: Mar. 3, 2005

(54) Pry bar for lifting vending machines

(76) Inventor: Lloyd E. Gunderson, Butte, MT (US)

Correspondence Address: Antoinette M. Tease, P.L.L.C., PO Box 51016, Billings, MT, 59105, US

(21) Appl. No.: 10/654,032

(22) Filed: Sep. 3, 2003

(51) Int. Cl. B62B 7/02

(52) U.S. Cl. 280/47.27

(57) ABSTRACT

An apparatus to facilitate the lifting of vending machines comprising a rigid bar, a handle attached to the rigid bar by a first metal plate, a second metal plate attached to the rigid bar with both a vertical and an oblique portion, and a wheel assembly. The oblique portion of the second metal plate comprises a flat section, a beveled edge, and a lip that engages the underside of the vending machine. The angle between the vertical and oblique portions of the second metal plate, the angle of the beveled edge, and the angle between the lip and the beveled edge are within specified ranges. The handle is coated with a rubberized material, the rigid bar is made from a material that provides the necessary strength and durability, and the wheels are made of polyurethane. A method of lifting a vending machine using the apparatus described herein.

### CROSS-REFERENCE TO RELATED APPLICATIONS

This application is an original nonprovisional application. It does not claim priority back to any previously filed patent application.

### BACKGROUND OF THE INVENTION

1. Field of the Invention

The present invention relates to the field of pry bars, hand trucks, dollies and similar mechanisms used to move heavy objects. In particular, the present invention is designed to lift vending machines for cleaning and maintenance purposes, or to position the machines so as to avoid vandalism or theft of the vending machine contents.

2. Description of the Related Art

Vending machines need to be moved periodically so that a person can get behind the machine to perform maintenance on it or to clean behind it. The issue of cleaning behind vending machines is particularly important in schools, hospitals, grocery stores and similar locations where it is necessary or desirable to maintain a sanitary environment. Vending machines also need to be moved easily so that they can be positioned close together or close to a wall or other structure to prevent vandalism or theft of the vending machine contents.

Current methods of moving vending machines are cumbersome and inefficient. They involve either: (i) standard hand carts, which do not grasp the vending machine as effectively as the present invention, are not as light and mobile as the present invention, can cause back injuries, and sometimes require the use of straps; or (ii) automation, which requires a power source. The prior art includes numerous examples of lifting mechanisms, but none of them is specifically designed for the ease of handling and effectiveness of use in connection with lifting vending machines.

For example, U.S. Pat. No. 879,914 (Schriver et al., 1908) describes a barrel-truck of simple construction that can be adjusted to lift different sized barrels. The patent claims a barrel-truck comprising an axle, wheels upon the axle, a frame composed of two rods bent at their lower ends into feet and bent at right angles at their upper ends into handles, brackets secured to the axle and the lower ends of the frame, lug nuts on the sides of the brackets for contacting the frame, a block with right angled channels for engaging the bends at the upper ends of the rods, and means (such as a chain) for holding a receptacle on the truck.

U.S. Pat. No. 1,374,372 (Freund, 1921) relates to a carrier designed for the purpose of lifting and transporting stoves, ranges and similar appliances over floor coverings. The invention consists of a unit that can be used singly or in multiples to move a heavy object. Each unit is identical in structure and includes an upright metallic post with a foot that has a caster beneath it and a hook on top of it, a screw shank further up the metallic post and an integral hook on the screw shank, and means for clamping the shank to the post.

U.S. Pat. No. 2,108,477 (De Gheselle, 1938) provides a refrigerator handling and moving device. The invention described in this patent consists primarily of a pair of duplicate opposed carriages. Each carriage has a roller for conveyance purposes and a foot at the bottom which underlies the refrigerator to be handled. The two trucks are placed against opposite sides of the refrigerator, and then a strap is buckled around the refrigerator. The refrigerator can then be tilted toward either of the two carriages and moved in that manner or moved with equal weight placed on both carriages.

U.S. Pat. No. 2,274,918 (Chenette, 1942) describes a completely rubber-sheathed lifting and carrying iron for moving heavy household articles that do not have hand holds and that have either leg or cabinet bases. The invention comprises one or more hooks or bearing members for supporting flat or cabinet base articles and leg-type appliances, caster means that swivel, handle means that pivot or rotate, and an elongated cushioned bearing member to prevent localized pressure on a small area of the article to be moved.

U.S. Pat. No. 3,306,624 (Goss, 1967) involves a dolly for moving boxes of glass. The primary object of this invention is to provide a dolly particularly adapted for picking up and moving rectangular boxes that are roughly three to four feet on a side and about two inches thick and that contain sheets of window glass. The dolly described in this patent was intended to allow for picking up and moving these boxes and depositing them in a vertical position in racks. The main feature of the invention is a pair of vertically parallel handles that allow a rectangular box to fit between them and rest on the bottom platform of the dolly.

U.S. Pat. No. 3,761,107 (Docherty et al., 1973) relates to a furniture-carrying device that has a pair of L-shaped parallel members with upright leg portions and horizontal leg portions. These parallel members are detachably but rigidly interconnected by a singular cross member that serves as a manual grip for carrying the device. The invention also includes detachable wheel assemblies mounted on the lower ends of the L-shaped members.

U.S. Pat. No. 3,857,579 (Hoodenpyle, 1974) describes a cart for moving television, hi-fi cabinets and the like. The cart has an L-shaped main frame with triangular sides along the shorter side of the frame and a handle extending transversely across the cart at the extremity of the longer end of the frame. An axle at the corner where the two ends of the frame meet supports ground wheels on either side, and there are also caster wheels on the bottom of the extremities of both the shorter and longer sides of the frame.

U.S. Pat. No. 5, 427,393 (Kriebel, 1995) covers a device for moving stackable crates that have hand grip orifices and bottom weight bearing flanges such as milk crates, egg crates, and break crates. The device comprises a lever and a handle means, hook, stop and roller means all attached to the lever. The only independent claim of this patent includes a limitation that relates to the facile dragging of stackable crates to different locations.

U.S. Pat. No. 6,059,512 (Kielinski, 2000) describes a lifting and moving apparatus designed to be useful in manipulating heavy objects such as loading ramps, pallets, chemical drums and other containers of substances, skid trucks and the like. The invention comprises a rigid bar with a pair of rollers on an axle at one end and a handle at the other end, and struts pivoted to the roller axle with a boom pivotally connected to their opposite ends. One end of the boom is connected to the rigid bar, and the other end has a hook that can be engaged with a loading ramp adapter or used to lift various objects. The boom can be secured in a collapsed position along the rigid bar, which allows the apparatus to be used as a pry bar. The invention also provides for various attachments, such as a hand truck adapter or a pallet truck adapter, to be connected to the apparatus.

Additional patents that describe hand trucks, dollies and similar moving devices will be disclosed in a subsequently filed Information Disclosure Statement.

### BRIEF SUMMARY OF THE INVENTION

The present invention is an apparatus designed to facilitate the lifting of vending machines for maintenance or cleaning purposes or so that they can be repositioned. The present invention is a pry bar comprising a rigid bar, a handle that is attached to the rigid bar by a first metal plate, a second metal plate that is attached to the rigid bar and that has both a vertical and an oblique portion, and a wheel assembly. What renders the present invention particularly unique is the oblique portion of the second metal plate, which comprises a flat section, a beveled edge, and a lip that engages the underside of the vending machine.

The present invention includes parameters for three angles. The first angle is the angle between the vertical portion of the second metal plate and the oblique portion of the second metal plate. That angle can range from 50 to 70 degrees. The second angle is the angle of the beveled edge of the oblique portion of the second metal plate, and that angle can be in the range of 10 to 30 degrees. The third angle is the angle between the lip and the beveled edge of the oblique portion of the second metal plate. That angle can range from 60 to 80 degrees. The apparatus of the present invention will perform its desired function if the three angles are within these parameters.

The present invention also provides that the handle is made of metal pipe and coated with a rubberized material for ease of grip, the rigid bar is tapered from bottom to top and made from a material selected from the group consisting of kiln dried wood, metal, fiberglass and phenolic plastic, all of which provide the necessary strength and durability. In the preferred embodiment, the wheel assembly comprises an axle, two wheels, a means for securing the wheels to the axle, and a means for securing the axle to the rigid bar, and the wheels are made of polyurethane to prevent scratching or scraping.

The present invention includes a method of lifting a vending machine using the apparatus described herein.

### BRIEF DESCRIPTION OF THE DRAWINGS

FIG. 1 is a pictorial illustration of a preferred embodiment of the present invention.

FIG. 2 is a front detail view of a preferred embodiment of the present invention.

FIG. 3 is a side detail view of a preferred embodiment of the present invention.

FIGS. 4A and 4B are side detail views of the bottom portion of a preferred embodiment of the present invention.

FIG. 5 is a side view of a preferred embodiment of the present invention in relation to a vending machine.

FIG. 6 is a back detail view of a preferred embodiment of the present invention.

### DETAILED DESCRIPTION OF THE INVENTION

By virtue of its unique construction and design, the present invention can be carried easily by one person, allows a single person to safely move a vending machine in a matter of minutes, and can lift up to 5000 pounds. The preferred embodiment of the present invention has a “lip” that is specifically designed to catch the bottom of a vending machine. Because it is manually operated, the present invention is less expensive and easier to operate than hydraulic or other automatic lifts, and it does not require straps, chains or any other accoutrements. The present invention minimizes back injuries that can be caused by other lifting mechanisms because it allows a vending machine to be moved without the operator having to assume the full weight of the machine. The present invention is safe to use, simple in construction, yet strong and durable.

The following figures illustrate a preferred embodiment of the present invention:

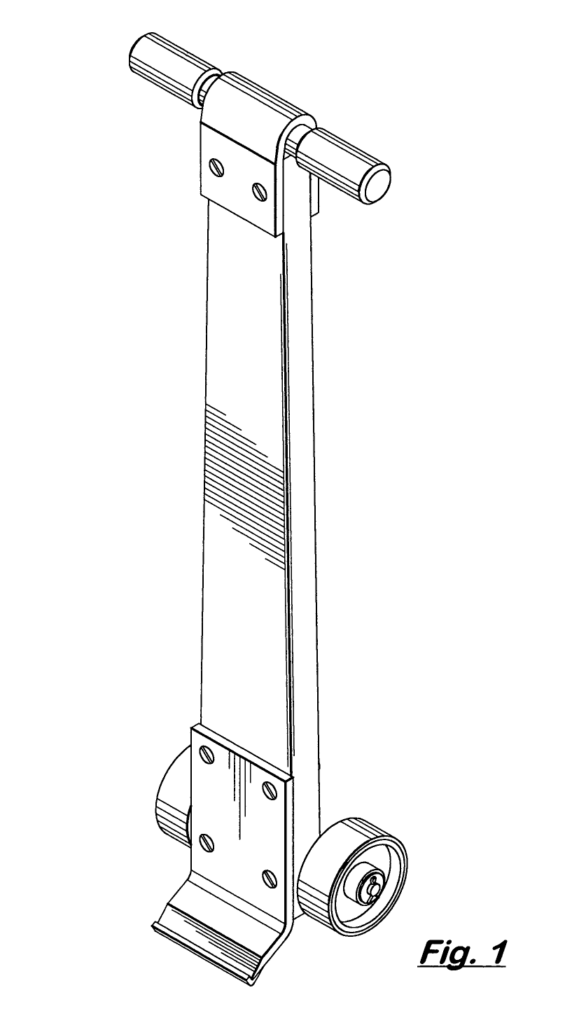

FIG. 1 is a pictorial illustration of a preferred embodiment of the present invention.

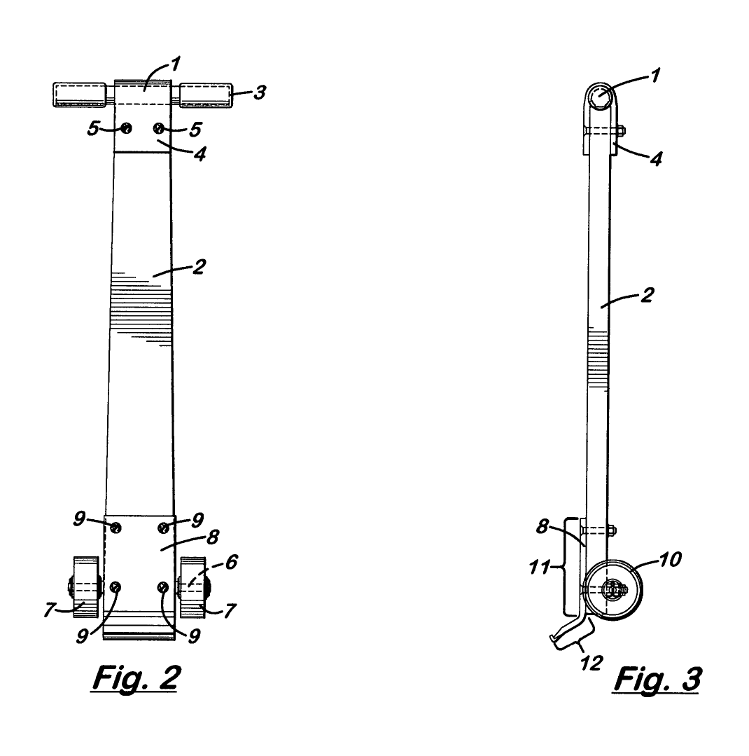

FIG. 2 is a front detail view of a preferred embodiment of the present invention. In the preferred embodiment, a handle 1 is attached to a rigid bar 2 that tapers slightly from bottom to top. In one embodiment, the rigid bar 2 is approximately four inches wide at the top and approximately six inches wide at the bottom, approximately 42 inches from top to bottom, and approximately one and three quarters inches thick. The rigid bar 2 can be constructed of any material that provides sufficient strength to withstand the weight of a vending machine, including, but not limited to, kiln dried oak, metal, fiberglass or phenolic plastic, all of which share this common characteristic. The rigid bar can also be tapered or non-tapered. The handle 1 can be of any configuration that allows the operator to manipulate the apparatus. In the preferred embodiment, the handle 1 is constructed of a one-inch (inside diameter) metal pipe, which is either wrapped with or dipped in a rubberized material 3 for ease of grip.

In the preferred embodiment, the handle 1 is connected to the rigid bar 2 by means of a first metal plate 4 that is wrapped around the handle 1 and extends down the front and back of the rigid bar 2. In the preferred embodiment, the first metal plate is approximately one eighth of an inch thick, three inches wide and 12 inches long. A four-inch length of the first metal plate extends down the front of the rigid bar, four inches of the first metal plate wrap around the handle, and a four-inch length of the first metal plate extends down the back of the rigid bar. In the preferred embodiment, the first metal plate is attached to the rigid bar with two bolts 5 that are positioned side by side.

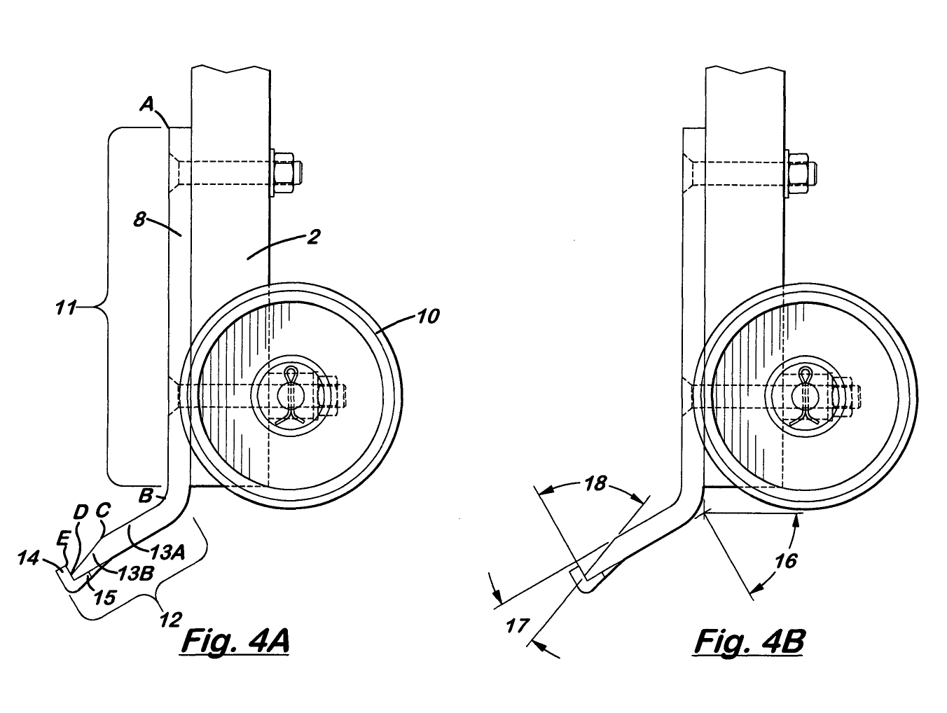

Attached to the back of the bottom portion of the rigid bar 2 is a wheel assembly. In the preferred embodiment, the wheel assembly consists of an axle 6, two wheels 7, and means of securing the wheels to the axle. In order to avoid scratching or scraping floors, the wheels are preferably made of polyurethane or similar hard yet non-abrasive material. In the preferred embodiment, the wheels are five inches in diameter and two inches wide. Attached to the front of the bottom portion of the rigid bar 2 is a second metal plate 8. The second metal plate is attached to the rigid bar by means of bolts 9 or other securing mechanism. The second metal plate is preferably one half inch thick (except at the beveled edge and lip, see FIG. 4A) and approximately six inches wide.

FIG. 3 is a side detail view of a preferred embodiment of the present invention. This figure shows the handle 1, the rigid bar 2, and the first metal plate 4 that attaches the handle to the rigid bar. It also shows the wheel assembly 10 and the second metal plate 8, which consists of a vertical portion 11 and an oblique portion 12.

FIG. 4A is a side detail view of the bottom portion of a preferred embodiment of the present invention. This figure illustrates the vertical portion 11 and the oblique portion 12 of the second metal plate 8, as well as the wheel assembly 10 and the bottom portion of the rigid bar 2. The oblique portion of the second metal plate consists of a flat section 13A, a beveled edge 13B and a lip 14. In one embodiment, the lip 14 is constructed of a one-quarter-inch L-shaped angle iron 15 welded to the beveled edge 13B of the oblique portion of the second metal plate. An alternative method of construction would be to mold the lip together with the rest of the second metal plate.

In the preferred embodiment, the length of the vertical portion of the second metal plate (point A to point B) is approximately eight and one half inches; the length of the flat section of the oblique portion of the second metal plate (point B to point C) is approximately two inches; the length of the beveled edge (point C to point D) is approximately one inch; and the length of the lip (point D to point E) is approximately one quarter inch. As a result of these dimensions, as illustrated in FIG. 4B, the angle 16 (“First Angle”) between the vertical portion and the oblique portion of the second metal plate is approximately 60 degrees; the angle 17 (“Second Angle”) of the beveled edge 13B of the oblique portion of the second metal plate is approximately 20 degrees; and the angle 18 (“Third Angle”) between the lip 14 and the beveled edge 13B is approximately 70 degrees. The angles provided in the illustration of the preferred embodiment can vary while still allowing the present invention to accomplish its intended function. For example, the First Angle can vary from 50 to 70 degrees, the Second Angle can vary from 10 to 30 degrees, and the Third Angle can vary from 60 to 80 degrees.

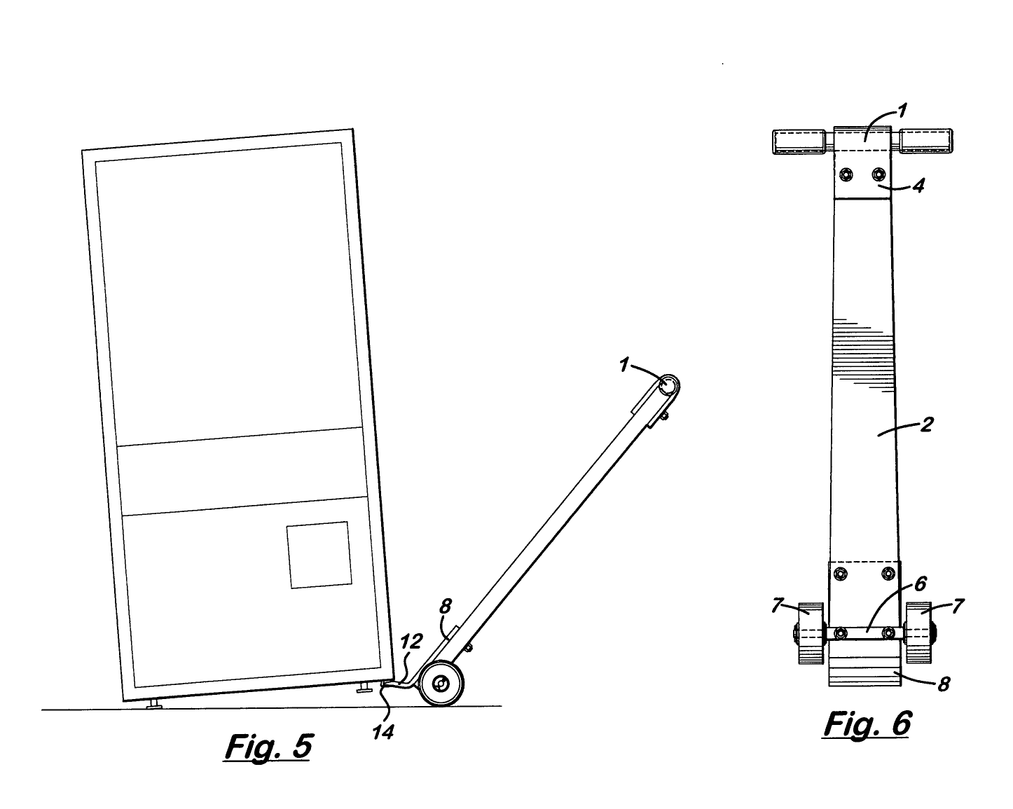

FIG. 5 is a side view of a preferred embodiment of the present invention in relation to a vending machine. As shown in this figure, the lip 14 of the oblique portion 12 of the second metal plate 8 engages the underside of the vending machine to allow for easy lifting. The present invention does not lift the vending machine entirely off the ground but rather lifts any one side of the vending machine to allow for gradual repositioning. The handle 1 allows for easy manipulation by the operator.

FIG. 6 is a back detail view of a preferred embodiment of the present invention. This figure shows the wheel assembly, which consists of an axle 6, two wheels 7, means for securing the axle to the rigid bar 2, and means for securing the wheels to the axle. This figure also shows the first metal plate 4, the handle 1, and a small portion of the back side of the second metal plate 8.

Although a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention. Any measurements included in the above description are intended to provide a general picture of the overall dimensions of the preferred embodiment but are not intended to limit the claims.

1. An apparatus for lifting vending machines comprising:
(a) a rigid bar;
(b) a handle that is attached to the rigid bar by a first metal plate;
(c) a second metal plate that is attached to the rigid bar, wherein the second metal plate has a vertical portion that lies flat against the rigid bar and an oblique portion that extends away from the rigid bar and that comprises a flat section (13A), a beveled edge (13B), and a lip that extends upward (14); and
(c) a wheel assembly.

2. The apparatus of claim 1 wherein the handle is made of metal pipe.

3. The apparatus of claim 1 wherein the handle is coated with a rubberized material.

4. The apparatus of claim 1 wherein the rigid bar is tapered from bottom to top.

5. The apparatus of claim 1, wherein the rigid bar is made from a material selected from the group consisting of kiln dried wood, metal, fiberglass and phenolic plastic.

6. The apparatus of claim 1 wherein the angle (16) between the vertical portion of the second metal plate and the oblique portion of the second metal plate is in the range of 50 to 70 degrees.

7. The apparatus of claim 1 wherein the angle (17) of the beveled edge of the oblique portion of the second metal plate is in the range of 10 to 30 degrees.

8. The apparatus of claim 1 wherein the angle (18) between the lip and the beveled edge of the oblique portion of the second metal plate is in the range of 60 to 80 degrees.

9. The apparatus of claim 1, wherein the wheel assembly comprises:
(a) an axle;
(b) two wheels;
(c) a means for securing the wheels to the axle; and
(d) a means for securing the axle to the rigid bar.

10. The apparatus of claim 9, wherein the wheels are made of polyurethane.

11. A method of lifting a vending machine using the apparatus of claim 1,2, 3,4,5,6,7,8,9 or 10.
